(19) United States
(12) Patent Application Publication
(10) Pub. No.: US 2006/0094270 A1
(43) Pub. Date: May 4, 2006

(54) Positioning device for securing earth line of a signal transferring unit

(76) Inventor: Mark Engler, San Gabriel, CA (US)

Correspondence Address: TROXELL LAW OFFICE PLLC, SUITE 1404, 5205 LEESBURG PIKE, FALLS CHURCH, VA, 22041, US

(21) Appl. No.: 10/979,236

(22) Filed: Nov. 3, 2004

(51) Int. Cl. H01R 13/648

(52) U.S. Cl. 439/108

(57) ABSTRACT

A signal transferring unit includes a base having a connector for connecting an inlet line and an outlet line. A bolt is threadedly connected to a hole defined in the base and the earth line extends through a transverse passage which is in communication with the hole. A protrusion extends longitudinally from a distal end of the positioning member and a positioning piece is rotatably mounted to the protrusion and has a recess defined in an underside thereof such that the earth line is engaged with the recess.

### FIELD OF THE INVENTION

The present invention relates to a positioning device including a bolt and a positioning piece rotatably mounted to the bolt, the positioning piece positioning the earth line without worry of damaging the earth line.

### BACKGROUND OF THE INVENTION

A conventional positioning device for positioning earth line of a signal transferring unit is disclosed in FIG. 6, and generally includes a base “a” with a connector “a1” whose two ends are respectively connected to an inlet line and an outlet line. A threaded hole “c1” is defined on a stepped surface of the unit and a transverse passage “c11” perpendicularly communicates with the threaded hole “c1”. An earth line “b” extends through the transverse passage “c11” and a bolt “c2” is threadedly connected to the threaded hole “c1” so that a distal end of the bolt “c2” is in contact with the earth line “b”. In order to firmly compress the earth line in position, the bolt “c2” usually threads too deep to compress the earth line “b”. The earth line “b” could be severely deformed or even broken.

The present invention intends to provide a positioning device that includes a positioning piece located between the bolt and the earth line which is positioned by the positioning piece.

### SUMMARY OF THE INVENTION

The present invention relates to a signal transferring unit which comprises a base having a connector with two connection ports so as to be connected with an inlet line and an outlet line. A hole is defined in the base and a passage is transversely defined in the base and communicates with the hole. An earth line extends through the passage. A positioning member is inserted in the hole and a protrusion extending longitudinally from a distal end of the positioning member so that a positioning piece is rotatably mounted to the protrusion. The positioning piece has a recess defined in an underside thereof so as to retain and contact the earth line.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the positioning device of the present invention together with the signal transferring unit;

FIG. 2 is a cross sectional view to show the positioning device of the present invention;

FIG. 3 is a perspective view to show that an earth line is positioned by the positioning device of the present invention

FIG. 4 is a cross sectional view to show that an earth line is positioned by the positioning device of the present invention

FIG. 5 shows that the stop member can be a washer, and

FIG. 6 is an exploded view to show a conventional positioning device.

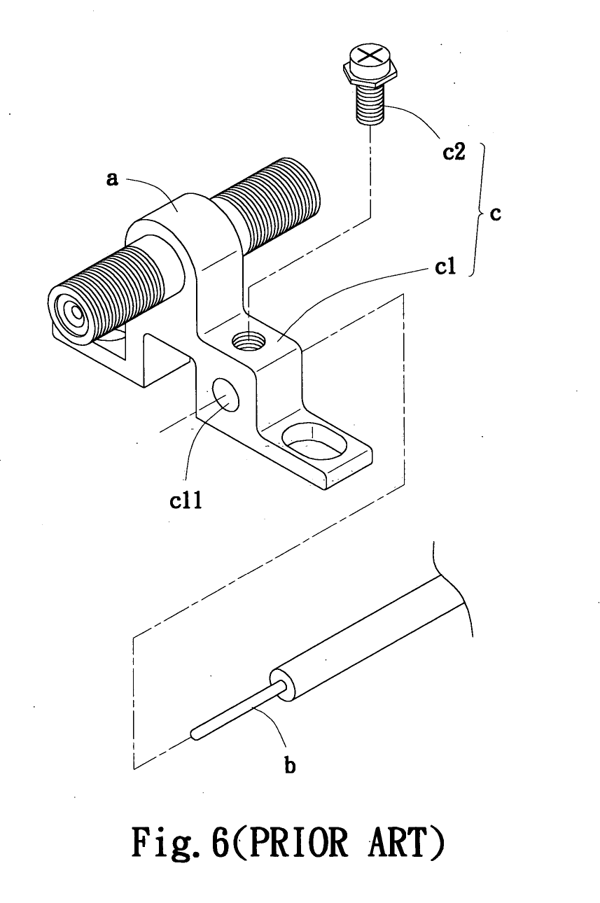

### DETAILED DESCRIPTION OF THE PREFERRED EMBODIMENT

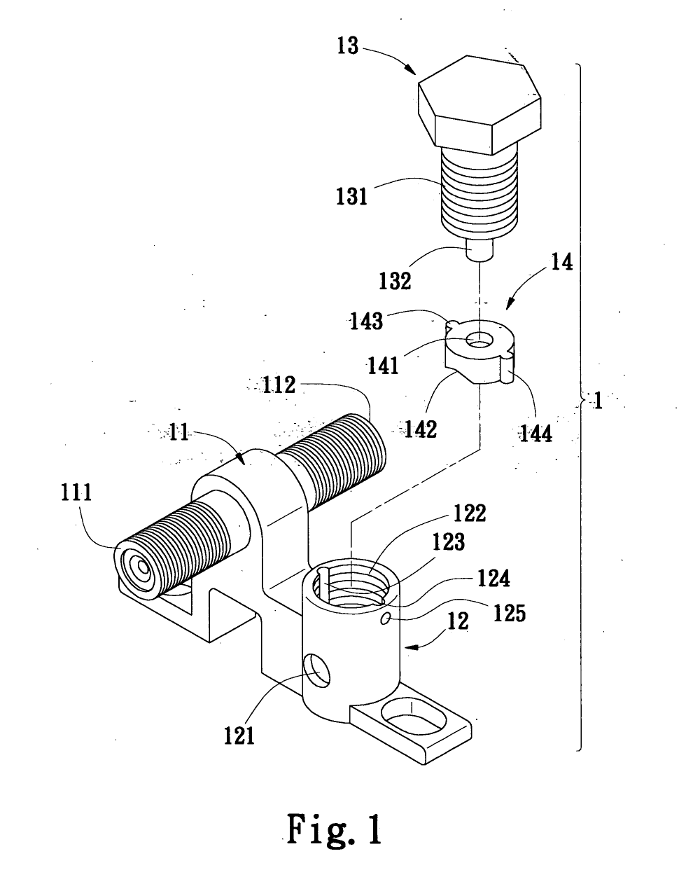

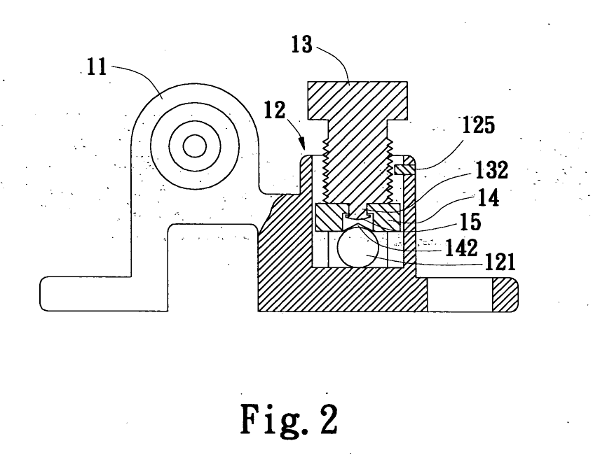

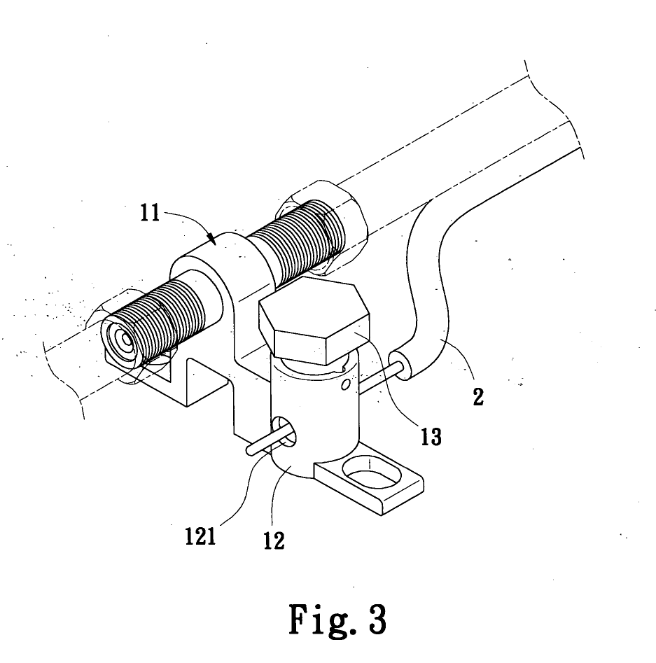

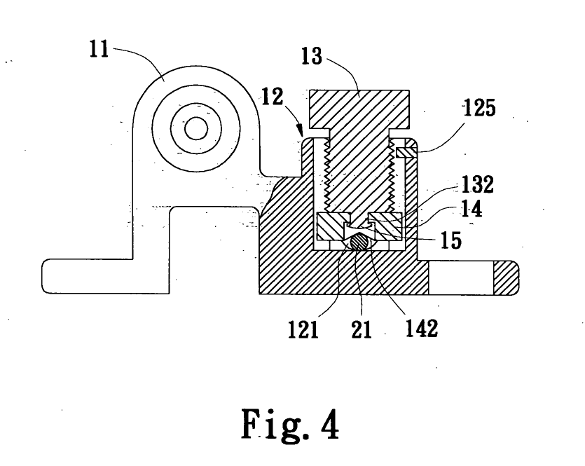

Referring to FIGS. 1 to 4, the signal transferring unit of the present invention comprises a base 11 having a connector with two connection ports 111, 112 for connecting an inlet line and an outlet line respectively (not shown). A tubular member 12 is located beside the connector and includes a hole such as a threaded hole 122 in this embodiment. Two grooves 123, 124 are defined in an inner periphery of the threaded hole 122. A passage 121 is transversely defined in the base 11 and communicates with the threaded hole 122 so that an earth line 2 extends through the passage 121.

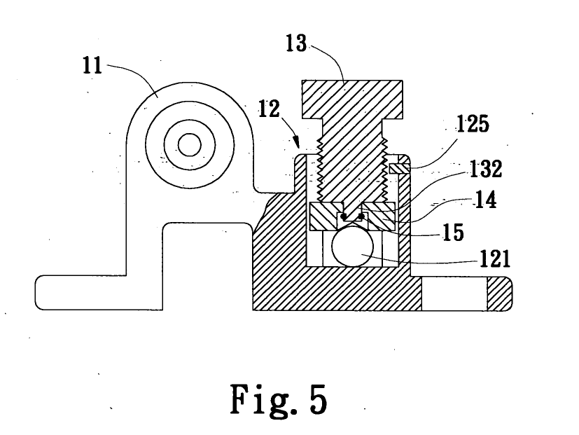

A positioning member 13 such as a bolt is threadedly connected to the threaded hole 122 and a protrusion 132 extends longitudinally from a distal end of a shank 131 of the positioning member 13. A positioning piece 14 has a through hole 141 in which the protrusion 132 is inserted so that the positioning piece 14 is rotatably mounted to the protrusion 132. A recess 142 is defined in an underside of the positioning piece 14 and two lugs 143, 144 extend from the positioning piece 14 so that the two lugs 143, 144 are movably engaged with the two grooves 123, 124. Therefore, the positioning piece 14 can only move longitudinally in the tubular member 12 and cannot rotate. A stop member 15 is connected to the protrusion 132 so that the positioning piece 14 is retained on the protrusion 132. The stop member 15 can be made integrally with the protrusion 132 or a washer 15′ as shown in FIG. 5.

The positioning piece 14 is lowered together with the movement of the positioning member 13 and the earth line 2 is compressed and retained by the recess 142. By this way, the earth line 2 is not over pressed or even broken.

A positioning pin 125 radially extends through a wall of the tubular member 12 and is in contact with the positioning member 13 so as to prevent the positioning member 13 from being loosened.

While we have shown and described the embodiment in accordance with the present invention, it should be clear to those skilled in the art that further embodiments may be made without departing from the scope of the present invention.

What is claimed is:

1. A signal transferring unit comprising:
a base having a connector with two connection ports, a hole defined in the base and a passage transversely defined in the base and communicating with the hole, the passage adapted to receive an earth line therein;
a positioning member inserted in the hole and a protrusion extending longitudinally from a distal end of the positioning member, and
a positioning piece rotatably mounted to the protrusion and having a recess defined in an underside thereof, the recess adapted to compress onto the earth line.

2. The unit as claimed in claim 1, wherein the hole is a threaded hole and the positioning member is a bolt which is threadedly connected to the threaded hole.

3. The unit as claimed in claim 1, wherein two grooves are defined in an inner periphery of the hole and the positioning piece includes two lugs which are movably engaged with the two grooves.

4. The unit as claimed in claim 1, wherein a stop member is connected to the protrusion so that the positioning piece is retained on the protrusion.

5. The unit as claimed in claim 4, wherein the stop member is a washer.

6. The unit as claimed in claim 1 further comprising a positioning pin radially extending through a wall enclosing the hole and in contact with the bolt.

7. The unit as claimed in claim 1 further comprising a through hole defined through the positioning piece and the protrusion being inserted in the through hole.
